(19) United States
(12) Patent Application Publication
(10) Pub. No.: US 2009/0292852 A1
(43) Pub. Date: Nov. 26, 2009

(54) Hard drive pod docking system

(75) Inventors: Bradley Justice, Richmond, CA (US); Peter Glanville, Ithaca, NY (US); Paul Russo, Slaterville Springs, NY (US)

Correspondence Address: Joseph B. Milstein;MILSTEIN INTELLECTUAL PROPERTY LAW LLC, 80 BEALS STREET, BROOKLINE, MA, 02446, US

(73) Assignee: Ithaca Technologies, LLC., Ithaca, NY (US)

(21) Appl. No.: 12/454,599

(22) Filed: May 20, 2009

Related U.S. Application Data
(60) Provisional application No. 61/128,204, filed on May 20, 2008.

(51) Int. Cl. G06F 13/00

(52) U.S. Cl. 710/303

(57) ABSTRACT

The invention relates to a hard drive dock (HDD) including a HDD enclosure having a first HDD outer surface and a second HDD outer surface. Each of the first HDD outer surface and the second HDD outer surface have disposed within an electrical connector configured to electrically connect to a releasably attached hard drive pod (HDP). The HDD includes a bridge circuit disposed within the HDD enclosure. The bridge circuit is configured to provide a communicative interface between the releasably attached HDP and the computer data bus connection. The HDD is mechanically configured to accept a releasably attached hard drive pod (HDP) on either or both of the first HDD surface and the second HDD surface. The invention also relates to a HDD enclosure having two or more HDD outer surfaces. The invention also relates to a releasably attached hard drive pod.

### CROSS-REFERENCE TO RELATED APPLICATIONS

This application claims priority to and the benefit of co-pending U.S. provisional patent application Ser. No. 61/128,204, HARD DRIVE POD DOCKING SYSTEM, filed May 20, 2008, which application is incorporated herein by reference in its entirety.

### FIELD OF THE INVENTION

This invention relates generally to a hard drive docking system and more particularly to a hard drive pod docking system.

### BACKGROUND OF THE INVENTION

Computer drives, once relegated mostly to the interior of computer cases, are now commonly found outside of the computer. The relatively recent proliferation of hard drives has at least in part been caused by the falling cost of hard drives. Also, storage needs ranging from distributed data storage, back up drives, as well as exchangeable drives have been factors in growing the hard drive market.

Perhaps the increase in relatively large video files is another reason that hard drives are close to becoming to the “floppy disc” of the 21st century. It is not uncommon, for example, for those doing video editing to use one or more hard drives per project, removing and inserting them, for example, in a computer hard drive bay as needed.

One of the draw backs of using standard hard drives as removable drives is that many drive bays require the installation of rails, slides, and/or front cover assemblies on the hard drive case. Another disadvantage of using standard hard drives is that when stored outside of the working enclosure, the drives are relatively unprotected and highly susceptible to corrosion caused by exposure, shock, or contamination damage, such as from condensation or liquid spills.

A slightly more protected alternative to the use of multiple “raw” hard drives is the hard drive enclosure solution offered by many manufacturers. In this format, each hard drive is typically combined with an electronic circuit on a printed circuit board (PCB) in a single case, such as a plastic case. The PCB provides a “bridge” between a hard drive, typically a SATA hard drive, and a computer connection such as a USB or firewire connector present at a surface of the external hard drive enclosure. Generally there is also present a low voltage power supply connection to an external power supply, such as a modular type power supply.

One problem with present multiple drive enclosures is that the “raw” drives are left substantially unprotected when outside of the enclosure. Another problem with external drives integrated into enclosures is that they are wasteful, requiring at least one bridge PCB per hard drive unit enclosure.

What is needed, therefore, is a “greener”, more protective, and more flexible removable hard drive system.

### SUMMARY OF THE INVENTION

In one aspect, the invention relates to a hard drive dock (HDD) including a HDD enclosure having a first HDD outer surface and a second HDD outer surface. Each of the first HDD outer surface and the second HDD outer surface have disposed within an electrical connector configured to electrically connect to a releasably attached hard drive pod (HDP). At least a third HDD outer surface has at least one computer electrical connector configured as a computer data bus connection. Also, the HDD is powered by a power connection. The HDD includes a bridge circuit disposed within the HDD enclosure. The bridge circuit is configured to provide a communicative interface between the releasably attached HDP and the computer data bus connection. The HDD is mechanically configured to accept a releasably attached hard drive pod (HDP) on either or both of the first HDD surface and the second HDD surface.

In one embodiment, the electrical connector configured to electrically connect to a releasably attached HDP is compatible with a selected one of SATA connection and PATA connection.

In another embodiment, the at least one computer electrical connector is selected from the group consisting of USB, FireWire™, and eSATA.

In yet another embodiment, the at least one computer electrical connector is compatible with an Ethernet.

In yet another embodiment, the first HDD surface and the second HDD surface are mechanically configured to overlappingly accept at least two HDP edges such that an HDP remains substantially in place on the HDD once so overlappingly installed.

In yet another embodiment, the releasably attached HDP is further latched to the HDD by a rotating locking mechanism.

In yet another embodiment, the releasably attached HDP is further latched to the HDD by one or more slidingly engaged fingers.

In yet another embodiment, the releasably attached HDP is further latched to the HDD by Velcro™.

In yet another embodiment, the power connection includes a source of power selected from the group consisting of USB, PoE (power over Ethernet), wired internal power supply, and wired external power supply.

In yet another embodiment, the HDD further includes RAID data redundancy.

In yet another embodiment, the at least one of the outer surface having disposed within an electrical connector is configured to electrically connect to a releasably attached piggyback hard drive pod (HDP), the electrical connector comprising enough electrical contacts to support two hard drives, the releasably attached piggyback HDP having an outer surface having disposed within an electrical connector configured to electrically connect to a releasably attached hard drive pod (HDP).

In yet another embodiment, the at least one of the outer surface has disposed within an additional electrical connector configured to electrically connect to a releasably attached piggyback hard drive pod (HDP), the releasably attached piggyback HDP having an outer surface having disposed within an electrical connector configured to electrically connect to a releasably attached HDP and wherein the additional electrical connector is configured to support the piggyback HDP.

In yet another embodiment, the HDD further includes N additional outer surfaces having disposed within an electrical connector configured to electrically connect to a releasably attached HDP and configured to accept up to N+2 releasably attached HDPs.

In another aspect, the invention relates to a hard drive dock including a hard drive dock (HDD) enclosure having two or more HDD outer surfaces having disposed within an electrical connector configured to electrically connect to a releasably attached hard drive pod (HDP) and a computer data bus electrical connector configured as a computer data bus connection. The HDD also includes a bridge circuit disposed within the HDD enclosure. The bridge circuit is configured to provide a communicative interface between the releasably attached HDP and the computer data bus connection. The HDD is mechanically configured to accept a releasably attached hard drive pod (HDP) on any of the HDD surfaces having disposed within an electrical connector configured to electrically connect to a releasably attached hard drive pod (HDP).

In one embodiment, the hard drive dock further includes a waffle pattern on the outer surfaces of the HDD enclosure, the waffle pattern having physical depressions configured to matingly engage a raised edge of at least one of the releasably attached HDP.

In another embodiment, the HDD enclosure is configured as a polygon and each of the HDD outer surfaces has disposed within an electrical connector includes a surface of the polygon.

In yet another aspect, the invention relates to a hard drive pod (HDP) configured to be releasably attached to a hard drive dock (HDD), the HDP including a HDP enclosure having an outer surface including an HDP electrical connector configured to electrically connect to a hard drive dock (HDD). The outer surface is bounded by at least two raised edges that extend outward from the outer surface. The HDP also includes a hard drive disposed within the HDP enclosure and electrically coupled to the HDP electrical connector. The at least two raised edges are configured to overlapping engage the HDD when the releasably attached HDP is attached to the HDD.

In one embodiment, the at least two raised edges are configured as legs to hold the outer surface off a supporting surface when the releasably attached HDP is not attached to the HDD.

In another embodiment, the HDP enclosure includes a color coding to indicate a particular use or type of data.

In yet another embodiment, the HDP enclosure further includes a selected one of pliable covering and pliable coating.

In yet another embodiment, the HDP enclosure further includes an internal protective padding material.

In yet another embodiment, the at least two raised edges are further configured to facilitate stacking of a plurality of HDPs when not attached to the HDD.

The foregoing and other objects, aspects, features, and advantages of the invention will become more apparent from the following description and from the claims.

### BRIEF DESCRIPTION OF THE DRAWINGS

For a further understanding of these and objects of the invention, reference will be made to the following Detailed Description, which is to be read in connection with the accompanying drawings, where:

FIG. 1 shows an exemplary hard drive pod packaged for use in the inventive hard drive docking system.

FIG. 2A shows a first perspective view of one exemplary embodiment of a drive dock suitable to accept up to two hard drive pods.

FIG. 2B shows a second perspective view of the drive dock shown in FIG. 2A.

FIG. 3 shows a perspective view of two drive pods as shown in FIG. 1, docked on a drive dock of FIG. 2A and FIG. 2B.

FIG. 4 shows a perspective view of three drive pods where one drive pod is “piggybacked” on another.

FIG. 5 shows a symbolic view of a drive pod having connectors that support the piggybacked drive of FIG. 4.

FIG. 6A shows a first perspective view of one exemplary embodiment of a drive dock suitable to accept up to two piggyback hard drive pods.

FIG. 6B shows a second perspective view of the drive dock shown in FIG. 6A.

The drawings are not necessarily to scale, emphasis instead generally being placed upon illustrating the principles of the invention. In the drawings, like numerals are used to indicate like parts throughout the various views.

### DETAILED DESCRIPTION

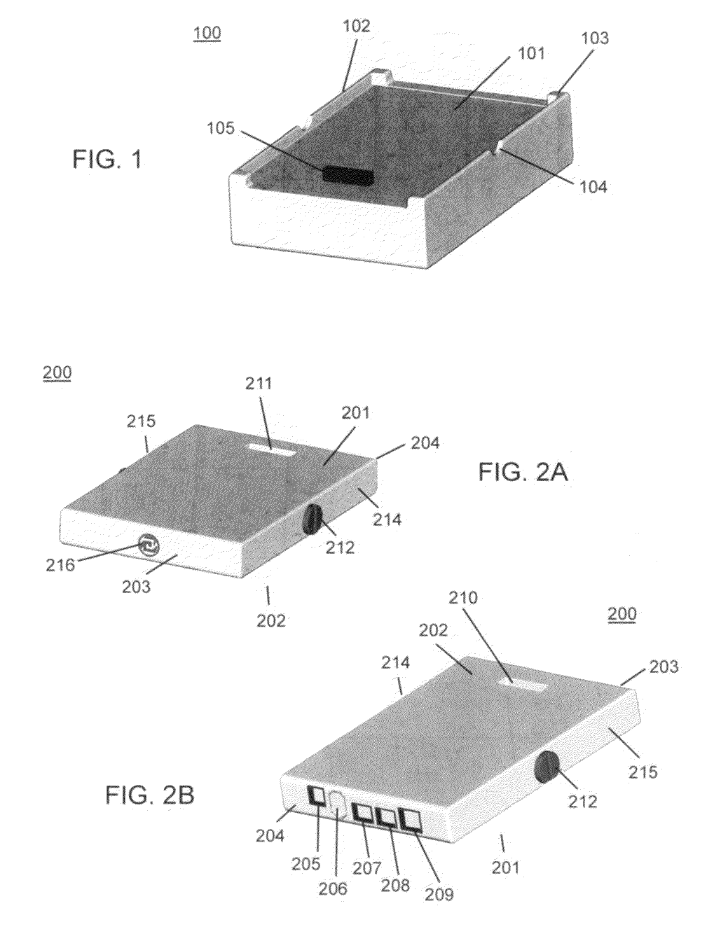

FIG. 1 shows an exemplary hard drive pod 100 packaged for use in the inventive hard drive docking system. Hard drive pod 100 can be substantially covered or encased by a material such as for example, a plastic, metal (using a suitable internal insulation), or epoxy. An electrical connector 105 can be used to electrically couple the hard drive pod 100 to a hard drive dock (not shown in FIG. 1) as described below. In some embodiments, connector 105 extends above a depressed surface 101.

Inside each hard drive pod 100 can be any suitable type of drive such as a hard drive or removable media drive. As defined below, the term “hard drive” includes a hard drive controller PCB, such as to provide basic control of the hard drive mechanisms and to provide a hard drive data connection such as a Serial Advanced Technology Attachment (SATA) or Parallel Advanced Technology Attachment (PATA). The term “hard drive” does not include a “bridge” PCB typically present as an interface between, for example, SATA or PATA and USB, FireWire™, or Ethernet. Hard drives suitable for use in hard drive pod 100 are presently commercially available from companies such as Seagate Technology LLC (Scotts Valley, Calif.), and the Western Digital Corporation (Lake Forest, Calif.).

The hard drive can be protected by a pliable covering material, such a pliable plastic or other protective elastomeric material. Or, where, for example, the covering material is a brushed or painted aluminum or stainless steel case, there can optionally be additional, typically electrically insulating, material inside of a metallic surface to offer mechanical shock resistance. Edge 102 defines a depressed surface 101 and offers alignment and stable mounting to the dock described below. In some embodiments, corners 103 can have additional material, typically the same as the surrounding surface material, to offer further mechanical support an impact protection to the corners of a hard drive pod 100.

One advantage of a hard drive pod 100 is that each hard drive pod 100 includes only one hard drive. Therefore a user of more than one or two hard drive pods 100 does not end up purchasing multiple bridge PCBs as is the case with multiple units of the typical standard prior art external drive.

Another advantage of a hard drive pod 100 is that the surface material and/or additional internal protective padding materials can offer substantial protection for each hard drive pods 100 when placed in off-dock storage. For example, where hard drive pods 100 are encased in plastic and stored in a “connector down” position, water leaking over them will likely not significantly damage the encased hard drive. In such cases, edges 102 and corners 103 further serve as feet (there can be additional rubber strips or bumpers on corners 103) and a partial dust barrier. There can also be additional members, typically on the outside of edge 102 to facilitate stacking drive pods 100 in storage. Where hard drive pods 100 are coated in a relatively soft or pliable plastic or other elastomeric material, the drive pods 100 can be somewhat impact resistant.

Also, some plastics or painted metals suitable for use as coating materials for hard drive pods 100 can be coded by well defined color tones. Colors can be used to indicate hard drive pod 100 users or specific projects. For example, drives dedicated to a particular amateur or professional movie project can all be of a certain blue color. A home business user might use magenta colored drives exclusively for backing up computer files. Other patterns, artwork, or alphanumeric symbols can also be used to identify individual hard drive pods 100. Also, as with any hard drive, once formatted, each hard drive pod 100 can have a unique identifier in software.

FIG. 2A shows a first view of one exemplary embodiment of a drive dock 200 suitable to accept up to two hard drive pods 100. A substantially flat surface 201 has within it a connector 211 that can electrically and mechanically couple to a connector 105 of a hard drive pod 100. Also, in many embodiments of drive docks, the length and width dimensions of surface 201 can be slightly smaller than the length and width dimensions of depressed surface 101 of a hard drive pod 100. Using such dimensional relationships, a hard drive pod 100 can be mechanically coupled to drive dock 200 by connecting electrical connector 105 with drive dock 200 and further mechanically seating a hard drive pod 100 such that edges 102 overlap in part surfaces 203, 214, 204, and 215 of drive dock 200. The partial overlap of edges 102 cause hard drive pod 100 to remain substantially in place on drive dock 200 once so overlappingly installed. Once properly seated on drive dock 200, a drive pod 100 can be secured to drive dock 200, for example, by rotatingly engaging a drive pod lock 212 configured to lock a drive pod 100 to the 201 surface. Note that where a circular surfaced rotating lock 212 is used, a similarly shaped opening 104 can be made in edge 102 of drive pod 100 to clear the lock 212.

FIG. 2B shows a second view of the drive dock 200 shown in FIG. 2A. In FIG. 2B, drive dock 200 has been rotated 180 degrees and flipped 180 degrees about both the vertical and one of the horizontal axis. Here it can be seen that as described above, a second drive pod 100 can be similarly affixed to surface 202 of drive dock 200. Note that in some embodiments, connectors 211 and 210 can be disposed on opposite sides of the surfaces of drive dock 200 (e.g. connector 211 near surface 204 and connector 210 near surface 203) to more conveniently route signals on the bridge PCB disposed within drive dock 200. Connectors 211 and 210 can be wired, as by ribbon cable, to the bridge PCB (not shown in FIG. 2A and FIG. 2B) or can be directly affixed to the bridge PCB. It is contemplated that in some embodiments, a drive dock 200 can be configured to accept different types of drive pods 100, by having additional types of connectors available at suitable locations on surfaces 201 and 202. In some such embodiments it might be desirable to mount such connectors off center as opposed to on the center line as shown in FIG. 2A and FIG. 2B.

Any multi-pin connector having enough unique connection pins suitable for electrically coupling to a particular type of hard drive incorporated into drive pod 100 can be used. Such connectors are commonly available that are capable of lifetimes of 5,000 and more insertion and removal operations. It is contemplated that one common connection can include both SATA and power connections between the hard drive incorporated into drive pod 100 and the bridge PCB disposed within a drive dock 200.

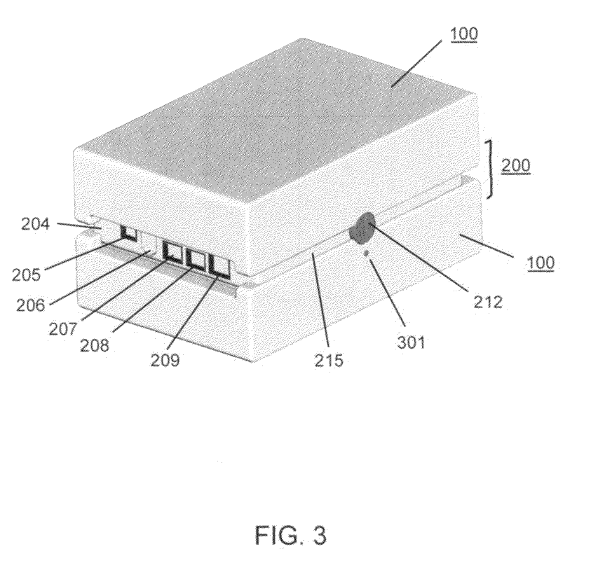

FIG. 3 shows a perspective view of two drive pods 100 as shown in FIG. 1, docked on a drive dock 200 of FIG. 2A and FIG. 2B. In FIG. 3, there is a partial view of surfaces 204 and 215 of drive dock 200. Lock 212 has been used to fasten the drive pod 100 to surface 201. The dot 301 on the surface 215 side of edge 102 of the drive pod 100 indicates which lock 212 is used to lock which drive pod 100 (i.e. the drive pod 100 on surface 201 or on surface 202).

While the exemplary embodiments of FIG. 1, FIG. 2A, and FIG. 2B show a rotating locking mechanism labeled as drive pod lock 212, it is contemplated that other locking mechanisms can be used. For example one or more “fingers” can slidingly engage suitable mating parts or features on a drive dock 200. Such fingers can include detents or edges for positively locking. Depending on the specific configuration used, buttons or depressible surfaces can be provided on either drive dock 200 or drive pods 100 to unlock such fingers. Other suitable locking mechanisms ranging from Velcro™ to various types of latches can also be used to positively affix drive pods 100 to a drive dock 200.

It should be noted that in most embodiments of the hard drive pod docking system there is no sense per se of up or down. Except in the unusual case where a particular type of hard drive or removable media drive incorporated into drive pod 100 needs to be operated at a certain orientation with respect to the Earth's gravitational field, a drive dock 200 can be oriented in virtually any position, typically resting on one of the five exposed sides of each of the docked drives pod 100.

Once one or two drive pods 100 are mechanically seated and electrically coupled to a bridge PCB within drive dock 200, a computer can also be communicatively coupled to the bridge PCB. Exemplary computer data bus connections include, but are not limited to, FireWire 800, FireWire 400, USB 2.0, and eSATA. The drive dock 200 of FIG. 3 shows an exemplary configuration having 4 connectors for data connections to a host, such as a host computer. Only one data connection is needed, although other contemplated embodiments offer two or more optional data connections. In FIG. 3, connector 206 can be used for a FireWire 400 data connection. Connectors 208 and 209 can be used for a FireWire 800 data connection. Here, two FireWire 800 connectors are shown for ease of FireWire “daisy chain” connections. In embodiments where one common FireWire interface services both the FireWire 400 and FireWire 400 connectors, FireWire connector 206 can also be part of a FireWire daisy chain. Connector 209 represents an optional USB connection, such as for a USB 2.0 connection. Also, an Ethernet connection, such as for connection by an Ethernet modular block connector can be included (not shown in FIG. 3). Note that in some embodiments a drive dock 200 can be attached to a component on a network, such as a network hub, to provide network attached storage (NAS). When connected to a network devices such as an Apple™ AirPort™, the NAS can become wireless via WiFi.

Power can be supplied to a drive dock 200 via a power connector such as is conceptually represented by connector 204. Other suitable shapes and sizes of power connectors can be used. Typically a low voltage external power supply can supply low voltage AC or DC to a drive dock 200 via a connector represented by connector 204. It is understood that where low voltage AC is supplied there can be an internal rectifier and one or more voltage regulators within a drive dock 200 (not shown in FIG. 3) and that where an external DC voltage is supplied there can be one or more voltage regulators within drive dock 200. Also, there can be a power supply within a drive dock 200 that can directly accept an AC mains voltage (e.g. 120 VAC) such as by direct line cord or via a suitable line cord connector. A drive dock 200 can also be powered in some cases by power over a USB connection. It is further contemplated that in some embodiments a drive dock 200 can be powered by Power over Ethernet (PoE).

The number of separate internally connected PCBs within a drive dock 200 is unimportant to the invention. In some embodiments, separate PCBs, for example a FireWire PCB, can be present in addition to the main bridge PCB that is wired to or directly includes connectors 211 and 210 (see FIG. 2A and FIG. 2B). In other embodiments, particularly in high volume production applications, substantially all of the electronics can be provided on one single PCB within a drive dock 200.

It should be noted that a company logo, trademark, or servicemark marking 216 (FIG. 2A) can be conveniently affixed, for example, to a surface 203 of a drive dock 200 so as to be still visible when one or two drive pods 100 are seated in drive dock 200.

It can now be seen that the combination of one or two drive pods 100 with a drive dock 200 provide a robust, yet attractive modular design approach. Only one power source (e.g. power by USB, Power over Ethernet (PoE), or wired external or internal power supply) is used per drive dock 200 as compared to use of two prior art hard drive enclosures using two separate power sources (usually a separate hard wired power supplies). Also, drives can easily be swapped without needing to open a case or even a door of a case. Moreover, each drive pods 100 includes only an encased hard drive, thereby avoiding duplication of bridge PCBs. It is further contemplated that such a dual docking system can be made fault tolerant by compliance with one or more of the RAID standards for data redundancy between multiple drives. One example of such a configuration is the use of a RAID 1 mode with a Glyph manager (available from Glyph Technologies of Ithaca, N.Y.). Other possible software configurations include Glyph Manager Software and JBOD (JBOD can be set as a default configuration), RAID 0, RAID 1, and Spanning modes.

Example: Two drive pods 100 each include an encased Seagate 3.5″ 7,200 RPM SATA drive. A drive dock 200 includes input output (I/O) connections for optional FireWire 800, FireWire 400, and USB 2.0 connections to another piece of equipment, such as, but not limited to, a personal computer.

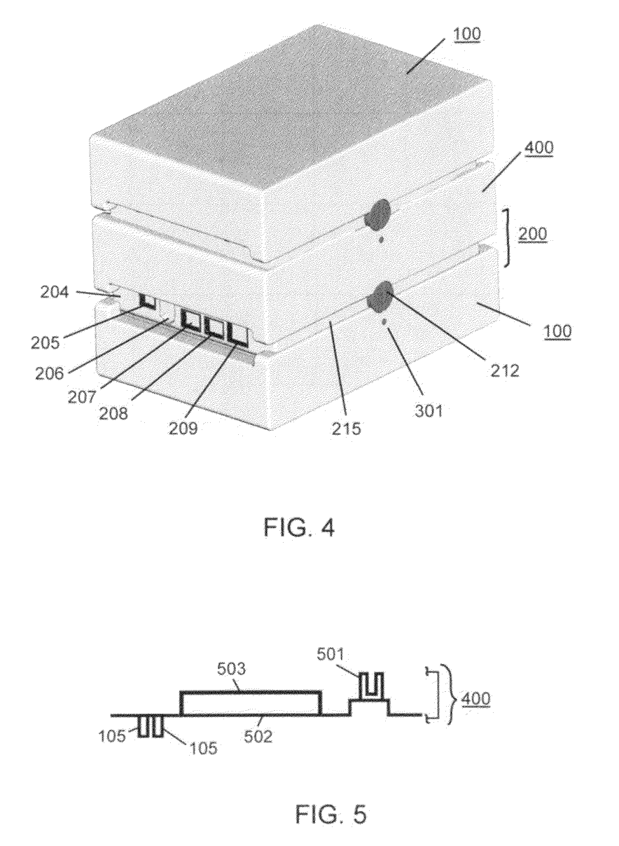

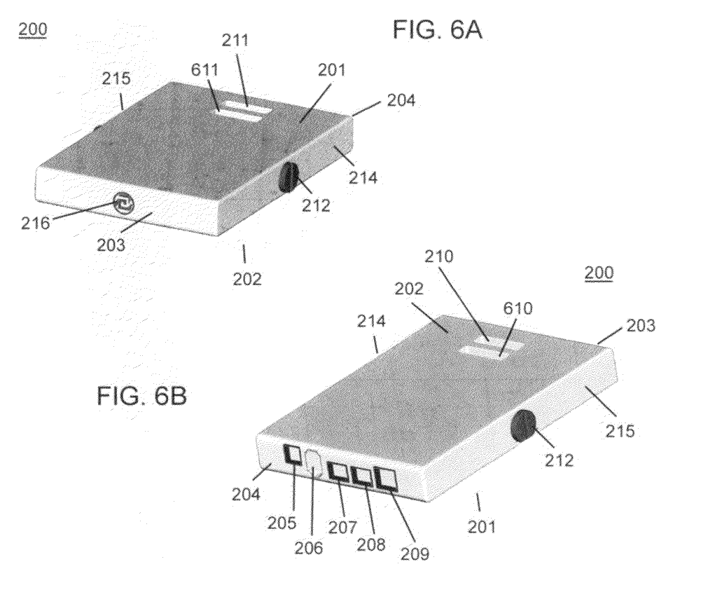

In another embodiment, there can be up to two additional “piggybacked” drive pods 100 disposed over each of two drive pods 400 attached to either or both of the two outer surfaces of a drive dock 200. FIG. 4 shows a perspective view of three drive pods where one drive pod 100 is piggybacked on a drive pod 400. To support the one or two piggybacked drive pods 100, there can be one or two drives 400. FIG. 5 shows a symbolic view of a drive pod housing a hard drive 503 and having connectors 105 and 501 to support the piggybacked drive of FIG. 4. Note that for piggybacking, one connector 105 of a drive pod 400 needs to have enough extra contacts to support a data connection from the bridge PCB within the drive dock 200 to the additional piggybacked drive pod 100. Or, alternatively, as shown in FIG. 5, a drive pod 400 can have a second connector 105. In the embodiment of a drive dock 200 shown in FIG. 6A and FIG. 6B, there are two connectors (211 and 611) on the outer surface shown in FIG. 6A and two connectors (210 and 610) on the outer surface shown in FIG. 6B. In some embodiments, a drive dock 200 as shown in FIG. 6A and FIG. 6B, can accept either a single connector 105 from a drive pod 100 or a double connector 105 from a drive pod 400. Note that one of the sets of data lines from one of the two connectors 105 is electrically connected through the drive pod 400, such as via a printed circuit board 502 (FIG. 5) to the piggyback connector 501.

Multiplicity: While the initial embodiments have been described using a rectangular shaped drive dock 200, other suitable shapes can be used to accommodate more drives. For example, a drive dock having a “waffle” patterned surface to matingly engage edges 102 can be configured to accept “N” drive pods 100 on one side as well as “N” drive pods 100 on an opposing side (just a as drive dock 200 accepts two drive pods 100 on opposing sides). Decorative drive pods 100 surface designs, pictures or covers, particularly in a waffle dock embodiment, when combined, e.g. as puzzle pieces, can present an overall pattern or picture.

A polyhedron waffle shaped (having, for example, indented or depressed lines on each surface to accept drive pods 100 edges 102) drive dock having “N” sides, can accept “N” drive pods 100. A polyhedron shaped drive dock can be conveniently hung from a ceiling, saving precious desk or shelf space, as well as presenting an attractive decorative hanging.

Green Technology: With the energy saving advantages stated above (e.g. only using one PCB per drive dock 200), the inventive hard drive pod docking system can be manufactured and marketed as a “Green” electronic product. It is contemplated that the hard drive pod docking system can be EnergyStar™ certified, and possibly conform in part or in whole to the new draft IEEE specification 1680 on Green electrical products. In particular, the modular design means that either drive dock 200 or a drive pod 100 can be replaced on failure thus also reducing municipal waste stream loading where “greener” products, such as the inventive hard drive pod docking system are used.

Definitions: A personal computer includes a desktop computer, laptop computer, notebook computer, PDA with suitable data connectors, cellular telephone having suitable data connectors, and any other type of fixed or handheld electronic device or instrument having a microcomputer and connectors suitable for making connection to a drive dock as described herein.

A hard drive includes, but is not limited to “spinning” hard drives of any available size. As used herein, the term “hard drive” includes at least one PCB that controls and provides a hard drive interface standard connection such as SATA or PATA. Typically in the case of external drives, a one or more intermediate “bridge” PCBs provide a further interface, between for example, SATA or PATA and computer interfaces such as, but not limited to serial interfaces, including for example, USB, FireWire, eSATA, or Ethernet. Such “bridge” PCBs are not included in our definition of the term “hard drive”. That is a “bridge” PCB is considered to be a separate component and not a part of a hard drive assembly.

Solid state drives of any type can also be encased to create drive pods 100. Other types of removable media drives, including for example CD, CDRW, DVD, DVDR, and Blu-ray™ drives can also be encased in part to create drive pods 100. Where there is further a removable media such as a disc, a slot like opening can be provided in the otherwise encased drive.

While the present invention has been particularly shown and described with reference to the preferred mode as illustrated in the drawing, it will be understood by one skilled in the art that various changes in detail may be affected therein without departing from the spirit and scope of the invention as defined by the claims.

We claim:

1. A hard drive dock (HDD) comprising:
a HDD enclosure having a first HDD outer surface and a second HDD outer surface, each of said first HDD outer surface and said second HDD outer surface having disposed within an electrical connector configured to electrically connect to a releasably attached hard drive pod (HDP) and at least a third HDD outer surface having at least one computer electrical connector configured as a computer data bus connection, said HDD powered by a power connection; and
a bridge circuit disposed within said HDD enclosure, said bridge circuit configured to provide a communicative interface between said releasably attached HDP and said computer data bus connection;
wherein said HDD is mechanically configured to accept a releasably attached hard drive pod (HDP) on either or both of said first HDD surface and said second HDD surface.

2. The HDD of claim 1, wherein said electrical connector configured to electrically connect to a releasably attached HDP is compatible with a selected one of SATA connection and PATA connection.

3. The HDD of claim 1, wherein said at least one computer electrical connector is selected from the group consisting of USB, FireWire™, and eSATA.

4. The HDD of claim 1, wherein said at least one computer electrical connector is compatible with an Ethernet.

5. The HDD of claim 1, wherein said first HDD surface and said second HDD surface are mechanically configured to overlappingly accept at least two HDP edges such that an HDP remains substantially in place on said HDD once so overlappingly installed.

6. The HDD of claim 1, wherein said releasably attached HDP is further latched to said HDD by a rotating locking mechanism.

7. The HDD of claim 1, wherein said releasably attached HDP is further latched to said HDD by one or more slidingly engaged fingers.

8. The HDD of claim 1, wherein said releasably attached HDP is further latched to said HDD by Velcro™.

9. The HDD of claim 1, wherein said power connection comprises a source of power selected from the group consisting of USB, PoE (power over Ethernet), wired internal power supply, and wired external power supply.

10. The HDD of claim 1, further comprising RAID data redundancy.

11. The HDD of claim 1, wherein at least one of said outer surface having disposed within an electrical connector is configured to electrically connect to a releasably attached piggyback hard drive pod (HDP), said electrical connector comprising enough electrical contacts to support two hard drives, said releasably attached piggyback HDP having an outer surface having disposed within an electrical connector configured to electrically connect to a releasably attached hard drive pod (HDP).

12. The HDD of claim 1, wherein at least one of said outer surface has disposed within an additional electrical connector configured to electrically connect to a releasably attached piggyback hard drive pod (HDP), said releasably attached piggyback HDP having an outer surface having disposed within an electrical connector configured to electrically connect to a releasably attached HDP and wherein said additional electrical connector is configured to support said piggyback HDP.

13. The HDD of claim 1, further comprising N additional outer surfaces having disposed within an electrical connector configured to electrically connect to a releasably attached HDP and configured to accept up to N+2 releasably attached HDPs.

14. A hard drive dock comprising:
a hard drive dock (HDD) enclosure having two or more HDD outer surfaces having disposed within an electrical connector configured to electrically connect to a releasably attached hard drive pod (HDP) and a computer data bus electrical connector configured as a computer data bus connection; and
a bridge circuit disposed within said HDD enclosure, said bridge circuit configured to provide a communicative interface between said releasably attached HDP and said computer data bus connection;
wherein said HDD is mechanically configured to accept a releasably attached hard drive pod (HDP) on any of said HDD surfaces having disposed within an electrical connector configured to electrically connect to a releasably attached hard drive pod (HDP).

15. The hard drive dock of claim 14, further comprising a waffle pattern on the outer surfaces of said HDD enclosure, said waffle pattern having physical depressions configured to matingly engage a raised edge of at least one of said releasably attached HDP.

16. The hard drive dock of claim 14, wherein said HDD enclosure is configured as a polygon and each of said HDD outer surfaces having disposed within an electrical connector comprises a surface of said polygon.

17. A hard drive pod (HDP) configured to be releasably attached to a hard drive dock (HDD), the HDP comprising:
a HDP enclosure having an outer surface including an HDP electrical connector configured to electrically connect to a hard drive dock (HDD), said outer surface bounded by at least two raised edges that extend outward from said outer surface; and
a hard drive disposed within said HDP enclosure and electrically coupled to said HDP electrical connector, wherein said at least two raised edges are configured to overlapping engage said HDD when said releasably attached HDP is attached to said HDD.

18. The HDP of claim 17, wherein said at least two raised edges are configured as legs to hold said outer surface off a supporting surface when said releasably attached HDP is not attached to said HDD.

19. The HDP of claim 17, wherein said HDP enclosure comprises a color coding to indicate a particular use or type of data.

20. The HDP of claim 17, wherein said HDP enclosure further comprises a selected one of pliable covering and pliable coating.

21. The HDP of claim 17, wherein said HDP enclosure further comprises an internal protective padding material.

22. The HDP of claim 17, wherein said at least two raised edges are further configured to facilitate stacking of a plurality of HDPs when not attached to said HDD.
